(19) United States
(12) Patent Application Publication
(10) Pub. No.: US 2008/0152888 A1
(43) Pub. Date: Jun. 26, 2008

(54) Methods and Systems for Providing Dyed, Stretchable Flame Resistant Fabrics and Garments

(75) Inventors: D. Craig Tutterow, Rome, GA (US); Rembert Joseph Truesdale, Thomaston, GA (US)

Correspondence Address: JOHN S. PRATT, ESQ;KILPATRICK STOCKTON, LLP, 1100 PEACHTREE STREET, ATLANTA, GA, 30309, US

(73) Assignee: Southern Mills, Inc., Union City, GA (US)

(21) Appl. No.: 11/852,755

(22) Filed: Sep. 10, 2007

Related U.S. Application Data
(60) Provisional application No. 60/843,251, filed on Sep. 8, 2006.

(51) Int. Cl. D06P 3/85; B32B 27/34

(52) U.S. Cl. 428/221; 8/531

(57) ABSTRACT

Flame resistant stretch fabrics made from aramid fibers and elastomeric fibers and methods and systems for dyeing such fabrics while significantly retaining the stretch properties of the fabrics. Such methods and systems include the use of certain dye carriers not conventionally used in the aramid dyeing process that enable the fabric to be dyed under normal aramid dyeing conditions without eliminating or significantly impacting the stretch properties of the fabric. Such suitable dye carriers for use in the process include, but are not limited to, benzyl alcohol, butyl benzoate, n-butyl phthalimide, isopropyl phthalimide, dimethyl phthalate, biphenyl, monochlorotoluene, and combinations thereof. Phthalimides, and more particularly blends of n-butyl phthalimide and isopropyl phthalimide, have proven particularly effective at dyeing the aramid fibers at high temperatures while retaining the elastomeric properties of the fabric. The dyed flame resistant stretch fabrics of this invention can be used to construct, among other things, the entirety or various portions of, a variety of protective garments for protecting the wearer against electrical arc flash and flames, including, but not limited to, coveralls, jumpsuits, shirts, jackets, vests, and trousers.

### CROSS REFERENCE TO RELATED APPLICATIONS

This application claims priority to U.S. Provisional Patent Application No. 60/843,251, titled “Methods and Systems for Providing Dyeable Stretchable Flame Resistant Fabrics and Garments,” filed Sep. 8, 2006, the entire contents of which is incorporated herein by reference.

### FIELD OF THE INVENTION

The present invention relates to novel methods and systems for dyeing aramid fibers in flame resistant stretch fabrics that better protect the elastomeric properties of such fabrics.

### BACKGROUND OF THE INVENTION

Flame resistant stretch fabrics formed from flame resistant (FR) fibers, including aramid fibers, such as para-aramid fibers and meta-aramid fibers, and elastomeric fibers are known. Examples of such fabrics are disclosed in U.S. Pat. Nos. 5,527,597 and 5,694,981, the entirety of each of which is hereby incorporated by reference. Flame resistant stretch fabrics are particularly suitable for use in industrial protective apparel where the wearer can be exposed to electric arc flash and flash fires, such as petrochemical, electrical, and utility workers. The flame resistance of the fabric protects the wearer against the thermal elements while the stretchability of the fabric affords the wearer improved range of motion.

Depending on the occupation of the wearer, it may be desirable that the fabrics (and thus the garments made therefrom) be a particular color, such as for safety and/or identification purposes. However, conventional dyeing systems, chemicals, and/or processes (including the relatively high temperatures) used to dye aramid fibers to obtain the desired color yield and laundry shrinkage can degrade the elastomeric fibers and thus detrimentally impact the elastomeric properties of the stretch fabric. While reduction in the temperature used to dye the aramid fibers can reduce the impact on the elastomeric fibers, the color yield and laundry shrinkage of the resulting fabric may be unacceptable. Thus, a need exists for a dyeing process that enables acceptable dyeing of aramid fibers in flame resistant stretch fabrics while retaining the stretch properties of the fabric.

### SUMMARY OF THE INVENTION

Embodiments of this invention include flame resistant stretch fabrics made from aramid fibers and elastomeric fibers and methods and systems for dyeing such fabrics while significantly retaining the stretch properties of the fabrics. The aramid and elastomeric fibers may be used to form various types of flame resistant stretch fabrics, including, but not limited to, nonwoven, woven, and knitted fabrics.

The aramid fibers in the flame resistant stretch fabrics may be dyed in accordance with the methods and systems disclosed herein so as not to significantly impact the stretch properties of the fabrics. More specifically, the inventors have discovered that certain dye carriers may be substituted for those conventionally used in the aramid dyeing process to enable the fabric to be dyed under normal aramid dyeing conditions (e.g., at temperatures between 185-300° F.) without eliminating or significantly impacting the stretch properties of the fabric. Such suitable dye carriers for use in the process include, but are not limited to, benzyl alcohol, butyl benzoate, n-butyl phthalimide, isopropyl phthalimide, dimethyl phthalate, biphenyl, monochlorotoluene, and combinations thereof. Phthalimides, and more particularly blends of n-butyl phthalimide and isopropyl phthalimide, have proven particularly effective at dyeing the aramid fibers at high temperatures while retaining the elastomeric properties of the fabric.

The dyed flame resistant stretch fabrics of this invention can be used to construct, among other things, the entirety of, or various portions of, a variety of protective garments for protecting the wearer against electrical arc flash and flames, including, but not limited to, coveralls, jumpsuits, shirts, jackets, vests, and trousers.

### BRIEF DESCRIPTION OF THE DRAWINGS

FIG. 1 is a top plan view of a portion of a flame resistant stretch fabric.

FIG. 2 is a top plan view of a portion of an alternative embodiment of a flame resistant stretch fabric.

### DETAILED DESCRIPTION OF THE DRAWINGS

Embodiments of this invention include fabrics made from aramid fibers and elastomeric fibers and methods of dyeing such fabrics while significantly retaining the stretch properties of the fabrics. Suitable aramid fibers include, but are not limited to, para-aramid fibers and meta-aramid fibers. Examples of para-aramid fibers include KEVLAR™ (available from DuPont), TECHNORA™ (available from Teijin Twaron BV of Arnheim, Netherlands), and TWARON™ (also available from Teijin Twaron BV). Examples of meta-aramid fibers include NOMEX™ (available from DuPont), CONEX™ (available from Teijin), and APYEIL™ (available from Unitika).

Suitable elastomeric fibers include, but are not limited to, spandex (elastane), ethylene-olefin copolymer, or similar elastomeric-type materials that have suitable stretchability or elasticity. Examples of spandex fibers include LYCRA™ (available from Invista), DORLASTAN™ (available from AsahiKasei Spandex America), and RadiciSpandex. Examples of ethylene-olefin copolymer fibers include Dow XLA™ composite fibers.

The aramid and elastomeric fibers may be used to form various types of flame resistant fabrics, including, but no limited to, nonwoven, woven, and knitted fabrics. In one embodiment, a fabric is formed of flame resistant yarns and elastomeric yarns woven together.

The flame resistant yarns preferably include aramid fibers, but can include additional fibers as well, including, but not limited to, polynosic rayon, flame resistant cellulosics such as flame resistant cotton or acetate, flame resistant polyester, polyvinyl alcohol, polytetrafluoroethylene, flame resistant wool, polyvinyl chloride, polyetheretherketone, polyetherimide, polyethersulfone, polychlal, polyimide, polyamide, polyimideamide, polyolefin, polybenzoxazole, polybenzimidazole fibers, pre-oxidized acrylic fibers, polyacrylonitrile fibers carbon, modacrylic, melamine, glass, or blends thereof. The flame resistant yarns can be formed in conventional ways well known in the industry. The yarns may be spun or filament yarns and can comprise a single yarn or two or more individual yarns that are plied together.

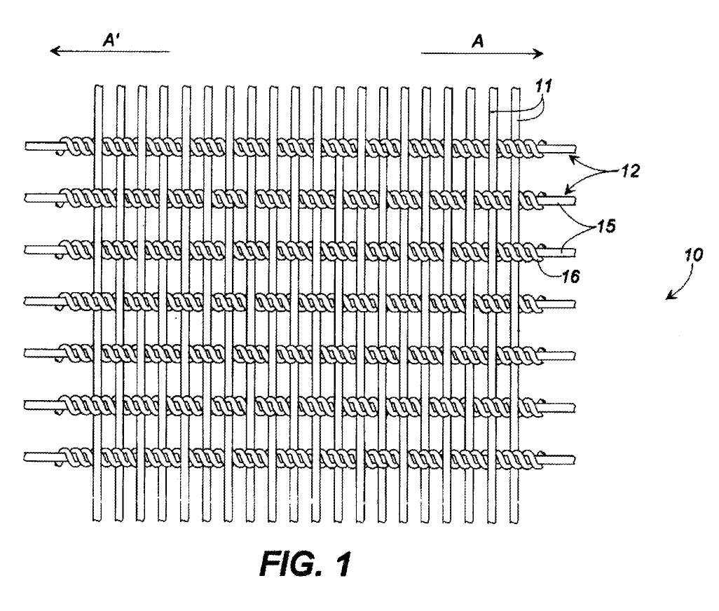

The elastomeric yarns are preferably filament yarns formed from the elastomeric fibers disclosed above. The elastomeric yarns are less durable and have a lower resistance to heat and fire than the flame resistant yarns and tend to degrade or melt from exposure to such extreme conditions. Thus, it may be desirable to orient the flame resistant yarns in the fabric so as to protect the elastomeric fibers against heat, flame, and abrasion. U.S. Pat. Nos. 5,527,597 and 5,694,981 illustrate fabric configurations whereby elastomeric core yarns 15 are helically wrapped with flame resistant yarns 16 (such as, but not limited to, those discussed above) to form an elastomeric composite yarn 12 (see FIG. 1). A single flame resistant yarn or multiple flame resistant yarns may be used to wrap a single elastomeric core yarn. In an alternative embodiment, the elastomeric composite yarn is a core spun yarn having an elastomeric core yarn with flame resistant fibers (such as, but not limited to, those disclosed above) spun around the elastomeric core yarn. In both composite yarn configurations, orientation of the flame resistant yarns/fibers around the elastomeric core yarns forms a protective sheath about the elastomeric core yarns to protect them from heat, flame, and abrasion.

In one embodiment, elastomeric composite yarns 12 oriented in either the fill/weft or warp direction are interwoven with flame resistant yarns oriented in the other of the fill/weft or warp direction to form a woven fabric having two-way stretch (i.e., stretchable in the direction of orientation of the elastomeric composite yarns). FIG. 1 illustrates a woven stretchable flame resistant fabric 10 comprising elastomeric composite yarns 12 oriented in the fill direction and flame resistant yarns 11 oriented in the weft direction. The fabric 10 is stretchable in the fill/weft direction as indicated by arrows A and A′.

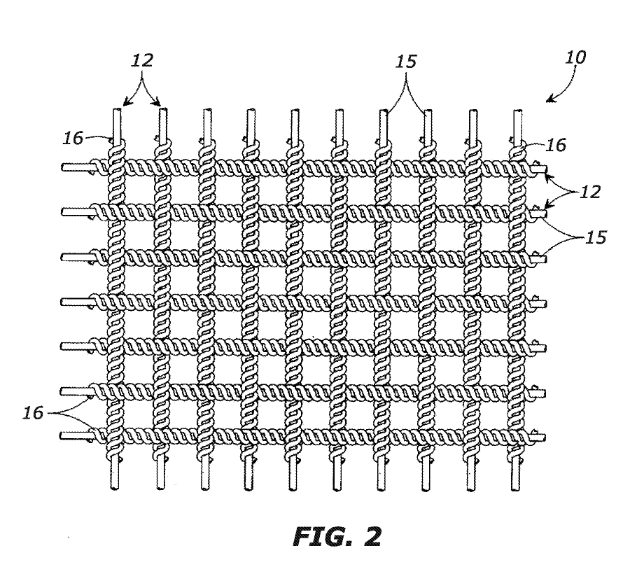

In an alternative embodiment (see FIG. 2), the fabric 10 is formed by weaving elastomeric composite yarns 12 together to form a woven fabric having four-way stretch (i.e., stretchable in the warp and weft directions). Although a plain weave is illustrated in these figures, it will be appreciated that other configurations could be used including, for instance, a rip-stop, twill weave, or knitted configuration.

After formation, the flame resistant stretch fabrics can be dyed. It may be desirable, but certainly not required, to subject the stretch fabrics to a pre-scouring process to remove from the elastomeric yarns oils that may interfere with dyeing. One such pre-scouring process includes subjecting the stretch fabrics to a detergent and water bath.

Dyeing of the aramid fibers in the fabrics may be achieved using a variety of dyeing techniques, including exhaust dyeing processes such as jet, beam, beck, and jig dyeing, all of which are well known in the art. In an exemplary exhaust dyeing process, a suitable dye, dye carrier, acid component, and nitrate salt are added to a dye bath in which the fabric is immersed. Other dyeing auxiliaries, including, but not limited to, leveling agents, defoamers, wetting agents, compatibilizers, wicking agent, oil scavenging agents, etc.—all well known in the art—may also be added to the dye bath. The temperature of the dye bath is gradually increased from room temperature to a peak temperature. This gradual increase in temperature is thought to promote even and uniform coloration. Upon reaching the predetermined peak temperature, the dye bath is maintained at this peak temperature for a time so as to allow the dye to fully penetrate the fibers.

Suitable dyes for dyeing the aramid fibers include, but are not limited to, disperse, cationic (basic), or acid dyes. The inventors have discovered that certain dye carriers may be substituted for those conventionally used in the aramid dyeing process to enable the fabric to be dyed under normal aramid dyeing conditions (e.g., at temperatures between 185-300° F.) without eliminating or significantly impacting the stretch properties of the fabric. Such suitable dye carriers for use in the process include, but are not limited to, benzyl alcohol, butyl benzoate, n-butyl phthalimide, isopropyl phthalimide, dimethyl phthalate, biphenyl, monochlorotoluene, and combinations thereof. Phthalimides, and more particularly blends of n-butyl phthalimide and isopropyl phthalimide, have proven particularly effective at dyeing the aramid fibers at high temperatures while retaining the elastomeric properties of the fabric. Phthalimides are available from Boehme-Filatex, which sells a variety of different phthalimide blends, including, but not limited to, BIP Phthalimides and Hipochem ARM, both of which include proprietary blends of n-butyl phthalimide and isopropyl phthalimide.

After dyeing, the fabric is preferably, but not necessarily, subjected to a process (including, but not limited to, a rinsing or scouring process) to remove as much residual dye carrier as possible from the fabric and thereby reduce the flammability of the fabric. The fabric can also be finished in a conventional manner. This finishing process can include the application of FR treatments, anti-microbial agents, insect repellent agents, pesticides, soil release agents, wicking agents, water repellents (e.g., fluropolymers), stiffening agents, softeners, and the like.

Stretch aramid fabrics dyed in accordance with this invention were found to retain their elastomeric properties while still achieving desired color yield and laundry shrinkage. Various stretch fabrics were tested to determine their elasticity and resiliency by measuring at least one of their dimensions (e.g., length, width, etc.) before, during, and after each was stretched in that dimension. For each tested fabric a sample was suspended from a test frame so that its direction of stretch was oriented substantially vertically. Two reference lines were drawn across the fabric an initial distance (I) from each other. A weight was then secured to the bottom of the fabric sample. After a period of time (e.g., 30 seconds) and while the fabric was still under the strain of the weight, the distance (A) between the reference lines was measured. The weight was then removed from the fabric sample, and the fabric sample was allowed to relax for a period of time (e.g., 60 seconds). After such period, the distance (R) between the reference lines was measured.

Percentage of stretch was calculated as follows:

$$\% Stretch = \frac{( A - I )}{I} * 100$$

Percentage of recovery was calculated as follows:

$$\% Recovery = \frac{( R - I )}{I} * 100$$

While not required, it may be desirable that the stretch fabrics dyed in accordance with the systems and methods of this invention have at least 10% stretch (and preferably more) and at least 85% recovery (and preferably more) as finished.

### EXAMPLE #1

Two stretch aramid fabrics were dyed in an exhaust dyeing process. The fabrics were each a 6 ounce plain weave NOMEX™ fabric having every other fill yarn replaced with an elastomeric composite yarn having elastic filament core yarns double-wrapped with NOMEX™ yarns. The fabrics differed only in the density of the elastomeric core yarn, where Fabric A was 140-denier and Fabric B was 240-denier. Both fabrics were pre-scoured at 170° F. for 15 minutes with nonionic scour at a pH between approximately 8-9. They were then introduced into a dye bath comprising Phthalimide blend 45 g/L, Acetic Acid 84% 5.00 g/L, 0.06% CI Acid Blue 193, 1.85% CI Basic Blue 41, and Nitrate Salt 18.00 g/L and dyed at 250° F. for 30 minutes at a pH between approximately 2-4. The fabrics were then post-scoured at temperatures ranging between 160° F.-200° F. in a series of water rinses. After this dyeing process, the stretch of the fabrics were measured as outlined in the test above. The stretch of the fabrics was then measured again after 5 laundering cycles.

The elasticity (% stretch) and resiliency (% recovery) of each fabric after dyeing and after five washes were as follows:

| | Fabric A | Fabric B |
|---|---|---|
| % stretch (pre-wash) | 13.3 | 13.5 |
| % recovery (pre-wash) | 90.6 | 84.6 |
| % fill stretch (after 5 | 20.4 | 21.7 |
| launderings) | | |
| % recovery (after 5 | 89.8 | 92.3 |
| launderings) | | |

This data indicates that the fabrics were able to make an almost ideal recovery (ideal recovery being a recovery of 100%) after being stretched and thus indicates that these fabrics retained a significant amount of their stretch properties during the dyeing process.

The benefits of the dyeing methods and systems of this invention are even more apparent when aramid stretch fabrics are dyed and their stretch properties after dyeing are compared with the stretch properties of aramid stretch fabrics subjected to only a water bath. Such a comparison emphasizes the relatively minimal impact that the dyeing methods and systems of this invention have on the stretch properties of the aramid stretch fabrics.

### EXAMPLE #2

Six stretch aramid fabrics were dyed in an exhaust dyeing process using Benzyl Alcohol as a dye assist.

Fabric 1 was a 6 ounce plain weave NOMEX™ fabric having every third fill yarn replaced with an elastomeric composite yarn having 140-denier elastic filament core yarns double-wrapped with NOMEX™ yarns.

Fabric 2 was a 6 ounce plain weave NOMEX™ fabric having every other fill yarn replaced with an elastomeric composite yarn having 140-denier elastic filament core yarns double-wrapped with NOMEX™ yarns.

Fabric 3 was a 6 ounce plain weave NOMEX™ fabric in which every fill yarn was replaced with an elastomeric composite yarn having 140-denier elastic filament core yarns double-wrapped with NOMEX™ yarns.

Fabric 4 was a 6 ounce plain weave NOMEX™ fabric having every third fill yarn replaced with an elastomeric composite yarn having 240-denier elastic filament core yarns double-wrapped with NOMEX™ yarns.

Fabric 5 was a 6 ounce plain weave NOMEX™ fabric having every other fill yarn replaced with an elastomeric composite yarn having 240-denier elastic filament core yarns double-wrapped with NOMEX™ yarns.

Fabric 6 was a 6 ounce plain weave NOMEX™ fabric in which every fill yarn was replaced with an elastomeric composite yarn having 240-denier elastic filament core yarns double-wrapped with NOMEX™ yarns.

A sample of each fabric was introduced into a dye bath comprising Benzyl Alcohol 70 g/L, Acetic Acid 84% 5.00 g/L, 1.85% Basic Blue 41 300%, and Nitrate Salt 18.00 g/L and dyed at 185° F. for 60 minutes at a pH between approximately 2-4. A sample of each fabric was also introduced to a water bath and subjected to the same temperature and for the same duration—185° F. for 60 minutes. After dyeing, the stretch of each of the twelve fabric samples was measured as outlined in the test above except that the fabrics were subjected to the strain of the weight for 60 seconds (instead of 30) and allowed to relax for 30 seconds (instead of 60). The results of the tests are outlined below:

| | Fabric 1 | Fabric 2 | Fabric 3 | Fabric 4 | Fabric 5 | Fabric 6 |
|---|---|---|---|---|---|---|
| % stretch (dye | 10.68 | 8.02 | N/A | 7.08 | 10.29 | 26.97 |
| bath) | | | | | | |
| % stretch | 11.79 | 19.46 | N/A | 42.86 | 34.02 | 40.82 |
| (water bath) | | | | | | |
| difference in | 1.11 | 11.44 | N/A | 35.77 | 23.73 | 13.85 |
| stretch % | | | | | | |
| between dyed | | | | | | |
| fabric and | | | | | | |
| identical fabric | | | | | | |
| subjected only | | | | | | |
| to water bath | | | | | | |

### EXAMPLE #3

Fabrics 1-6 (described in Example # 2 above) were dyed in an exhaust dyeing process using BIP Phthalimide (available from Boehme-Filatex) as a dye assist.

A sample of each fabric was introduced into a dye bath comprising BIP Phthalimide 45 g/L, Acetic Acid 84% 5.00 g/L, 1.85% Basic Blue 41 300%, and Nitrate Salt 18.00 g/L and dyed at 250° F. for 30 minutes. A sample of each fabric was also introduced to a water bath and subjected to the same temperature and for the same duration—250° F. for 30 minutes. After these baths, the stretch of each of the twelve fabric samples was measured as outlined in Example #2 above. The results of the tests are outlined below:

| | Fabric 1 | Fabric 2 | Fabric 3 | Fabric 4 | Fabric 5 | Fabric 6 |
|---|---|---|---|---|---|---|
| % stretch (dye | 8.94 | 10.34 | 28.00 | N/A | 20.74 | 28.88 |
| bath) | | | | | | |
| % stretch | 12.73 | 11.16 | 28.24 | N/A | 36.51 | 48.70 |
| (water bath) | | | | | | |
| difference in | 3.79 | 0.82 | 0.24 | N/A | 15.77 | 19.83 |
| stretch % | | | | | | |
| between dyed | | | | | | |
| fabric and | | | | | | |
| identical fabric | | | | | | |
| subjected only | | | | | | |
| to water bath | | | | | | |

### EXAMPLE #4

Fabrics 1-6 (described in Example # 2 above) were dyed in an exhaust dyeing process using Hipochem ARM Phthalimide Blend (also available from Boehme-Filatex) as a dye assist.

A sample of each fabric was introduced into a dye bath comprising Hipochem ARM Phthalimide Blend 45 g/L, Acetic Acid 84% 5.00 g/L, 1.85% Basic Blue 41 300%, and Nitrate Salt 18.00 g/L and dyed at 250° F. for 30 minutes. A sample of each fabric was also introduced to a water bath and subjected to the same temperature and for the same duration—250° F. for 30 minutes. After these baths, the stretch of each of the twelve fabric samples was measured as outlined in Example #2 above. The results of the tests are outlined below:

| | Fabric 1 | Fabric 2 | Fabric 3 | Fabric 4 | Fabric 5 | Fabric 6 |
|---|---|---|---|---|---|---|
| % stretch (dye | 10.39 | N/A | 25.55 | 4.33 | 15.04 | 37.56 |
| bath) | | | | | | |
| % stretch | 12.73 | N/A | 28.24 | 7.86 | 36.51 | 48.70 |
| (water bath) | | | | | | |
| difference in | 2.34 | N/A | 2.69 | 3.53 | 21.46 | 11.15 |
| stretch % | | | | | | |
| between dyed | | | | | | |
| fabric and | | | | | | |
| identical fabric | | | | | | |
| subjected only | | | | | | |
| to water bath | | | | | | |

The data collected from Examples #2-4 demonstrate that the fabrics (particularly those dyed with phthalimide dye carriers and more particularly the BIP Phthalimide dye carrier) retained a significant amount of their stretch properties during the dyeing process. Based on the work documented herein, it is preferable that the % stretch of a flame resistant stretch fabric dyed pursuant to embodiments of this invention not deviate more than approximately 25% (i.e., the fabrics retain at least approximately 75% of their stretch)—and more preferably not deviate more than approximately 10% (i.e., the fabrics retain at least 90% of their stretch) and most preferably not deviate more than approximately 5% (i.e., the fabrics retain at least 95% of their stretch)—from the % stretch of an identical flame resistant stretch fabric not subjected to such dyeing (i.e., subjected to a water bath instead of a dye bath). Fabrics dyed in accordance with the processes and systems described herein that exhibit such a small difference in % stretch as compared to identical fabrics subjected to treatment in a water bath indicate that such dyeing processes and systems have substantially minor effect on the elastic properties of the elastomeric fibers in the fabrics.

The dyed flame resistant stretch fabrics of this invention can be used to construct, among other things, the entirety or various portions of, a variety of protective garments for protecting the wearer against electrical arc flash and flames, including, but not limited to, coveralls, jumpsuits, shirts, jackets, vests, and trousers.

While particular embodiments of dyed flame resistant stretch fabrics for protective garments have been disclosed in detail in the foregoing description and drawings for purposes of example, it will be understood by those skilled in the art that variations and modifications thereof can be made without departing from the scope of the disclosure.

We claim:

1. A method of dyeing a flame resistant fabric comprising aramid fibers and elastomeric fibers, the method comprising introducing the fabric into a dye bath comprising a dye and at least one dye carrier, wherein the at least one dye carrier comprises at least one of benzyl alcohol, butyl benzoate, n-butyl phthalimide, isopropyl phthalimide, dimethyl phthalate, biphenyl, or monochlorotoluene.

2. The method of claim 1, further comprising heating the dye bath to a temperature between approximately 185-300° F., inclusive.

3. The method of claim 1, wherein the dye carrier comprises a blend of n-butyl phthalimide and isopropyl phthalimide.

4. The method of claim 1, wherein the dye comprises a disperse, basic, or acid dye.

5. The method of claim 1, further comprising scouring the fabric prior to introducing the fabric into the dye bath.

6. The method of claim 1, wherein the % stretch of the fabric dyed in accordance with claim 1 does not deviate more than approximately 25% from the % stretch of an identical flame resistant fabric subjected to a water bath.

7. The method of claim 6, wherein the % stretch of the fabric dyed in accordance with claim 1 does not deviate more than approximately 10% from the % stretch of an identical flame resistant fabric subjected to a water bath.

8. The method of claim 7, wherein the % stretch of the fabric dyed in accordance with claim 1 does not deviate more than approximately 5% from the % stretch of an identical flame resistant fabric subjected to a water bath.

9. The method of claim 1, wherein the aramid fibers comprise at least one of meta-aramid fibers or para-aramid fibers.

10. The method of claim 1, wherein the elastomeric fibers comprise at least one of spandex fibers or ethylene-olefin copolymer fibers.

11. The method of claim 1, wherein the flame resistant fabric is woven.

12. The method of claim 11, wherein the woven fabric comprises flame resistant yarns and elastomeric yarns, the flame resistant yarns comprising aramid fibers and the elastomeric yarns comprising elastomeric fibers.

13. The method of claim 12, wherein the at least some of the elastomeric yarns are at least partially wrapped with flame resistant yarns.

14. The method of claim 12, wherein the elastomeric yarns are filament yarns.

15. A fabric dyed in accordance with the method of claim 1.

16. A garment comprising the fabric of claim 15.

17. A dyed flame resistant fabric comprising aramid fibers, elastomeric fibers, and a residual amount of at least one dye carrier, wherein the at least one dye carrier comprises at least one of benzyl alcohol, butyl benzoate, n-butyl phthalimide, isopropyl phthalimide, dimethyl phthalate, biphenyl, or monochlorotoluene.
